(19) United States
(12) Patent Application Publication
(10) Pub. No.: US 2012/0137320 A1
(43) Pub. Date: May 31, 2012

(54) SYSTEM AND METHOD FOR STREAMING MULTIMEDIA CONTENT VIA A CELLULAR NETWORK TO MOBILE MULTIMEDIA DEVICES

(76) Inventors: SATISH MUGULAVALLI, Bangalore (IN); PRAKASH BHALERAO, Cupertino, CA (US)

(21) Appl. No.: 13/304,723

(22) Filed: Nov. 28, 2011

Related U.S. Application Data
(60) Provisional application No. 61/433,200, filed on Jan. 15, 2011.

(30) Foreign Application Priority Data
Nov. 30, 2010 (IN) 3623/CH/2010

(51) Int. Cl. H04W 4/00; H04N 7/16

(52) U.S. Cl. 725/25; 725/62

(57) ABSTRACT

A system and method for streaming multimedia content via a cellular network to mobile multimedia devices are disclosed. In one embodiment, an encoded multimedia stream is received by the cellular network via Internet. The encoded multimedia stream includes content metadata, live content and/or on-demand content. Further, the encoded content metadata, live content and/or on-demand content are routed by a multimedia streaming system in the cellular network. Furthermore, the routed content metadata is sent to one or more of the mobile multimedia devices by the multimedia streaming system via the cellular network. In addition, the routed live content and/or on-demand content are adaptively streamed to the one or more of the mobile multimedia devices by the multimedia streaming system via the cellular network. Also, the adaptively streamed live content and/or on-demand content are adaptively decoded by each of the one or more mobile multimedia devices.

This application claims priority under 35 U.S.C 119(a) to India Provisional Application No. 3623/CHE/2010 entitled “System and method for delivering multimedia content using a cellular network” by Satish Mugulavalli et al. filed on Nov. 30, 2010, which is incorporated herein by reference.

This application claims priority under 35 U.S.C 119(e) to U.S. Provisional Application No. 61/433,200 entitled “System and method for delivering multimedia content using a cellular network” by Satish Mugulavalli et al. filed on Jan. 15, 2011, which is incorporated herein by reference.

### FIELD OF INVENTION

Embodiments of the present subject matter relate to the field of streaming multimedia content via a network. More particularly, embodiments of the present subject matter relate to streaming the multimedia content via a cellular network to mobile multimedia devices.

### BACKGROUND

Currently, multimedia content providers are increasingly using Internet to provide multimedia content, such as live content, on-demand content and the like to mobile multimedia devices. Generally, the mobile multimedia devices obtain the multimedia content by connecting to Internet using mobile communication network services. The mobile communication network services are provided by associated mobile communication networks which employ a cellular infrastructure. One problem with the cellular infrastructure is that users of the mobile multimedia devices experience fading signals as the users move into and out of coverage areas of base stations associated with the mobile communication networks. For example, in a moving vehicle, a multimedia content viewer typically experiences such fading signals as the vehicle moves in and out of the coverage areas of the base stations. Due to such fading signals, the connectivity between the mobile multimedia devices and the associated mobile communication network is interrupted. Also in such situations, the users experience multimedia content buffering delays due to bandwidth limitations. This may result in an unsatisfied experience to the users of the mobile multimedia devices.

### BRIEF DESCRIPTION OF THE DRAWINGS

Various embodiments are described herein with reference to the drawings, wherein:

FIG. 1 illustrates a flow chart of an exemplary method of streaming multimedia content via a cellular network to mobile multimedia devices;

FIG. 2 illustrates a system for streaming the multimedia content via the cellular network to the mobile multimedia devices, according to one embodiment;

FIG. 3 is a block diagram illustrating major components in a multimedia streaming system, such as the one shown in FIG. 2, according to one embodiment;

FIG. 4 illustrates major modules residing in each of the major components in the multimedia streaming system, such as those shown in FIG. 3, according to one embodiment;

FIG. 5 is a block diagram illustrating major components in a mobile multimedia device, such as the one shown in FIGS. 2 and 3, for receiving the multimedia content from the cellular network, according to one embodiment;

FIG. 6 is a block diagram illustrating major components in a media processor residing in a set-top box, such as those shown in FIG. 5, for receiving the multimedia content from the cellular network, according to one embodiment;

FIG. 7 is a block diagram illustrating a display device and speakers integrated into a mobile multimedia device, according to one embodiment; and

FIG. 8 is a block diagram illustrating the mobile multimedia device, such as the one shown in FIGS. 2 and 3, installed inside an automobile for receiving the multimedia content from the cellular network, according to one embodiment.

The drawings described herein are for illustration purposes only and are not intended to limit the scope of the present disclosure in any way.

### DETAILED DESCRIPTION

A system and method for streaming multimedia content via a cellular network to mobile multimedia devices are disclosed. In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

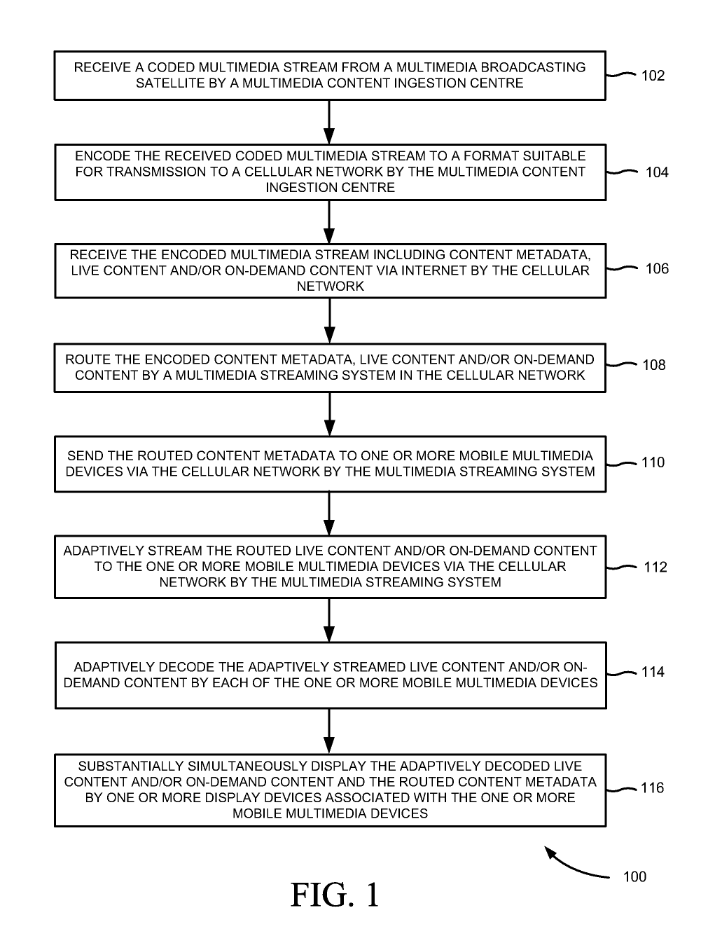

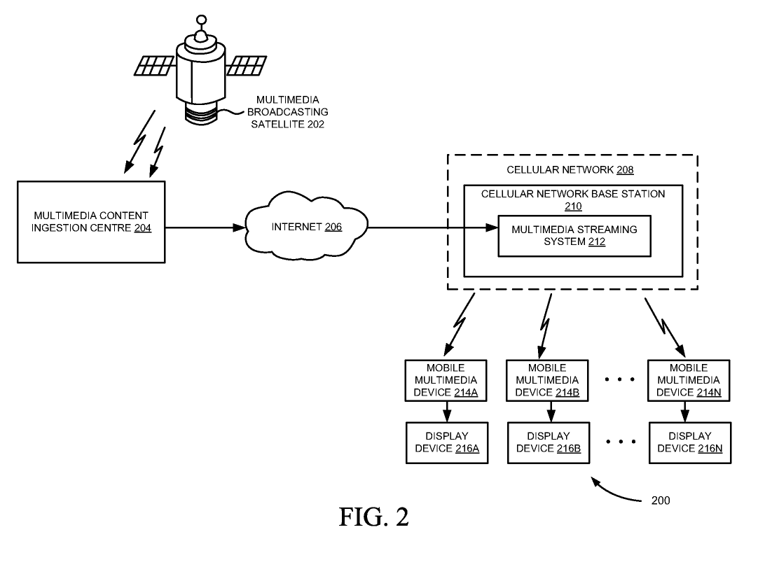

FIG. 1 illustrates a flow chart 100 of an exemplary method of streaming multimedia content via a cellular network to mobile multimedia devices. At block 102, a coded multimedia stream is received by a multimedia content ingestion centre from a multimedia broadcasting satellite. At block 104, the received coded multimedia stream is encoded to a format suitable for transmission to the cellular network by the multimedia content ingestion centre. Further, the encoded multimedia stream is transmitted to the cellular network by the multimedia content ingestion centre via Internet. At block 106, the encoded multimedia stream is received by the cellular network via Internet. The encoded multimedia stream includes multimedia content, such as content metadata, live content and/or on-demand content. This is explained in more detail with reference to FIG. 2.

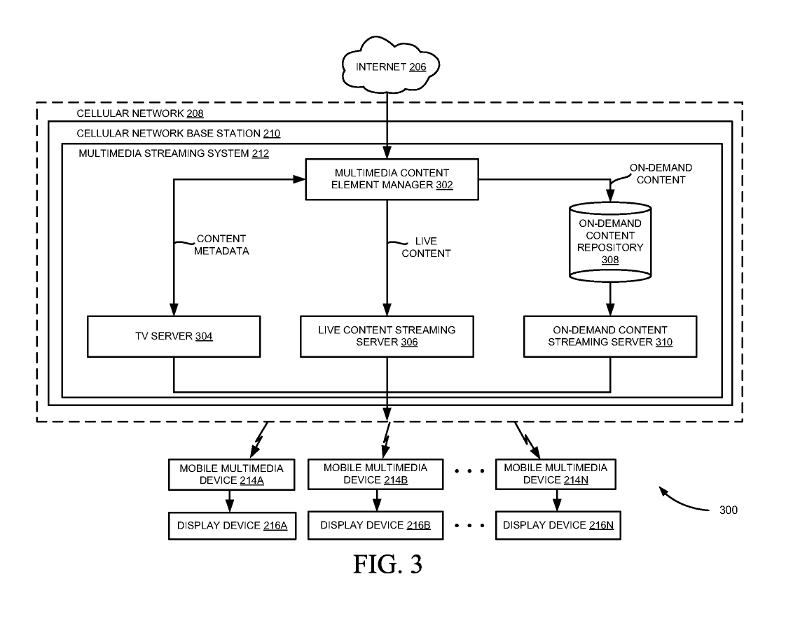

At block 108, the encoded content metadata, live content and/or on-demand content are routed by a multimedia streaming system in the cellular network. In one embodiment, the encoded content metadata is routed to a television (TV) server, live content to a live content streaming server and/or on-demand content to an on-demand content streaming server via an on-demand content repository by a multimedia content element manager residing in the multimedia streaming system. This is explained in more detail with reference to FIG. 3.

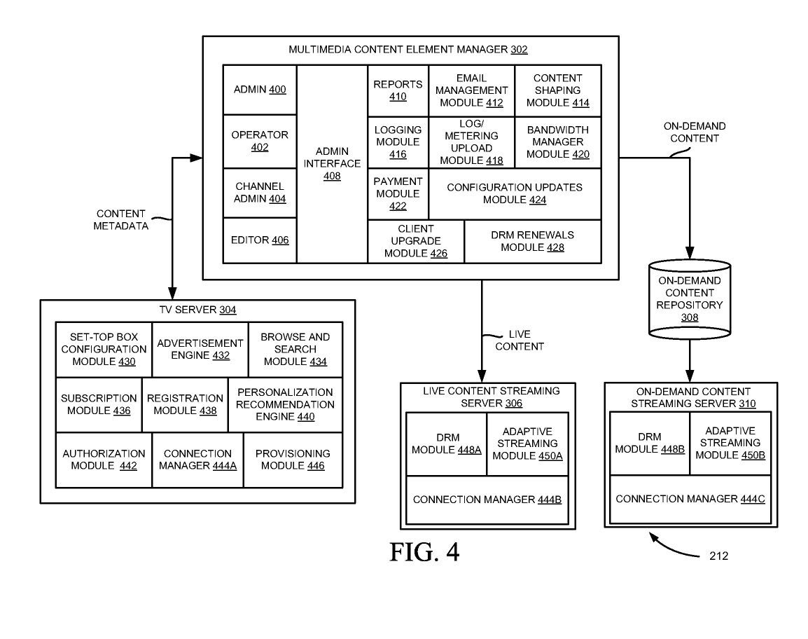

At block 110, the routed content metadata is sent to one or more of the mobile multimedia devices via the cellular network by the multimedia streaming system. In one embodiment, the routed content metadata is sent to the one or more of the mobile multimedia devices by an associated connection manager in the TV server. This is explained in more detail with reference to FIG. 4.

At block 112, the routed live content and/or on-demand content are adaptively streamed to the one or more of the mobile multimedia devices via the cellular network by the multimedia streaming system. In one embodiment, the routed live content is adaptively streamed to the one or more of the mobile multimedia devices by the live content streaming server in the multimedia streaming system. Further, the routed on-demand content is adaptively streamed to the one or more of the mobile multimedia devices by the on-demand content streaming server in the multimedia streaming system. In this embodiment, the routed live content and on-demand content are adaptively streamed to the one or more of the mobile multimedia devices by the live content streaming server and the on-demand content streaming server, respectively, using an associated adaptive streaming module, a digital rights management (DRM) module and a connection manager. This is explained in more detail with reference to FIG. 4.

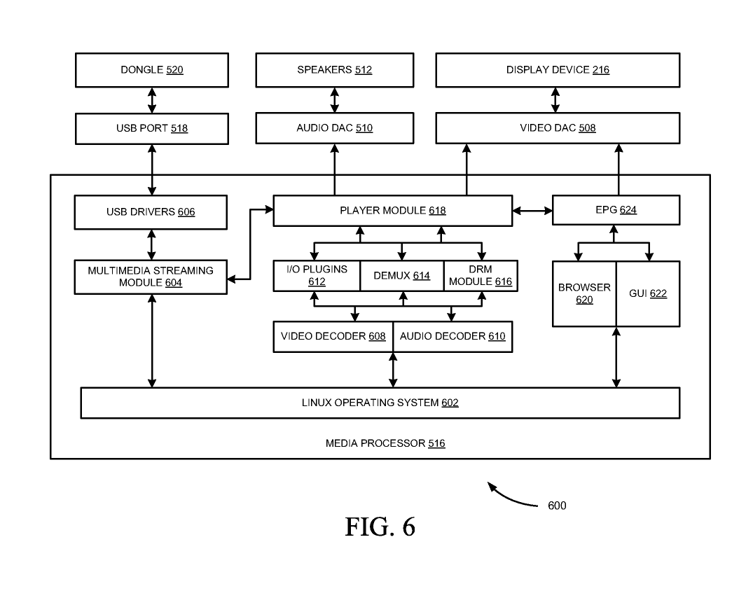

At block 114, the adaptively streamed live content and/or on-demand content are adaptively decoded by each of the one or more mobile multimedia devices. In one embodiment, the adaptively streamed live content and/or on-demand content are adaptively decoded by an associated multimedia streaming module and a player module, in a set-top box, in each of the one or more mobile multimedia devices. This is explained in more detail with reference to FIG. 6. At block 116, the adaptively decoded live content and/or on-demand content and the routed content metadata are substantially simultaneously displayed by one or more display devices associated with the one or more of the mobile multimedia devices.

Referring now to FIG. 2, which illustrates a system 200 for streaming the multimedia content via a cellular network 208 to a plurality of mobile multimedia devices 214A-N, according to one embodiment. As shown in FIG. 2, the system 200 includes a multimedia broadcasting satellite 202, a multimedia content ingestion centre 204, a cellular network base station 210, the mobile multimedia devices 214A-N and a plurality of display devices 216A-N. The cellular network base station 210 is associated with the cellular network 208. Exemplary cellular network 208 includes a code division multiple access (CDMA) network, a third generation (3G) mobile communication network and the like. Further as shown in FIG. 2, the cellular network base station 210 includes a multimedia streaming system 212.

Furthermore as shown in FIG. 2, the multimedia broadcasting satellite 202 is communicatively coupled to the multimedia content ingestion centre 204. In addition, the multimedia content ingestion centre 204 is coupled to the multimedia streaming system 212 via Internet 206. Moreover, the mobile multimedia devices 214A-N are coupled the multimedia streaming system 212 via the cellular network 208. Also, each of the display devices 216A-N is coupled to an associated one of the mobile multimedia devices 214A-N.

In operation, the multimedia content ingestion centre 204 receives a coded multimedia stream from the multimedia broadcasting satellite 202. Further in operation, the multimedia content ingestion centre 204 encodes the received coded multimedia stream to a format suitable for transmission to the cellular network 208. The encoded multimedia stream is then transmitted to the cellular network 208 via Internet 206. In this embodiment, the encoded multimedia stream includes multimedia content, such as content metadata, live content and/or on-demand content.

Furthermore in operation, the multimedia streaming system 212, in the cellular network 208, receives the encoded content metadata, live content and/or on-demand content. In addition, the multimedia streaming system 212 routes the encoded content metadata, live content and/or on-demand content. This is explained in more detail with reference to FIG. 3. Moreover, the multimedia streaming system 212 sends the routed content metadata to one or more of the mobile multimedia devices 214A-N. The multimedia streaming system 212 then adaptively streams the routed live content and/or on-demand content to the one or more of the mobile multimedia devices 214A-N via the cellular network 208. This is explained in more detail with reference to FIG. 4.

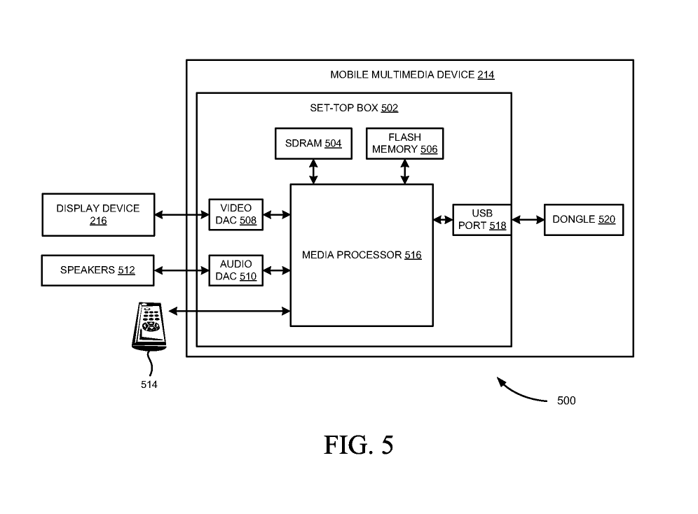

Further in operation, the one or more of the mobile multimedia devices 214A-N adaptively decodes the adaptively streamed live content and/or on-demand content. This is explained in more detail with reference to FIG. 6. Furthermore, the adaptively decoded live content and/or on-demand content and the routed content metadata are displayed by one or more of the display devices 216A-N associated with the one or more of the mobile multimedia devices 214A-N. This is explained in more detail with reference to FIGS. 5, 7 and 8.

Referring now to FIG. 3, which is a block diagram 300 illustrating major components in the multimedia streaming system 212, such as the one shown in FIG. 2, according to one embodiment. As shown in FIG. 3, the block diagram 300 includes the multimedia streaming system 212 residing in the cellular network base station 210 associated with the cellular network 208. Further as shown in FIG. 3, the multimedia streaming system 212 includes a multimedia content element manager 302, a TV server 304, a live content streaming server 306, an on-demand content repository 308 and an on-demand content streaming server 310.

Furthermore as shown in FIG. 3, the multimedia content element manager 302 is coupled to the TV server 304, the live content streaming server 306 and the on-demand content repository 308. For example, the multimedia content element manager 302 is coupled to the TV server 304, the live content streaming server 306 and the on-demand content repository 308 via Ethernet. In addition, the on-demand content repository 308 is coupled to the on-demand content streaming server 310. For example, the on-demand content repository 308 is coupled to the on-demand content streaming server 310 via Ethernet.

In operation, the multimedia streaming system 212 receives the encoded content metadata, live content and/or on-demand content from the multimedia content ingestion centre 204, shown in FIG. 2, via Internet 206. Particularly, the multimedia content element manager 302 in the multimedia streaming system 212 receives the encoded content metadata, live content and/or on-demand content. Further, the multimedia content element manager 302 routes the encoded content metadata, live content and on-demand content to the TV server 304, the live content streaming server 306 and the on-demand content repository 308, respectively. This is explained in more detail with reference to FIG. 4.

In one embodiment, the routed content metadata is sent to the one or more of the mobile multimedia devices 214A-N by the TV server 304. This is explained in more detail with reference to FIG. 4. The routed content metadata includes a list of programs associated with the routed live content (also referred to as scheduled content) and/or on-demand content. The routed content metadata is then substantially simultaneously displayed on the one or more of the display devices 216A-N associated with the one or more of the mobile multimedia devices 214A-N. Further, viewers associated with the one or more of the mobile multimedia devices 214A-N browse through the list of programs associated with the routed live content and/or on-demand content using the associated one or more of the display devices 216A-N. Furthermore, each of the viewers selects a program from the list of programs associated with the routed live content and/or on-demand content. Based on the program selected by each of the viewers, corresponding content requests are sent to the multimedia streaming system 212 by the associated one or more of the mobile multimedia devices 214A-N. Particularly, the content requests are sent to the TV server 304 in the multimedia streaming system 212.

Furthermore in this embodiment, upon receiving the content requests, the TV server 304 authorizes each of the viewers. This is explained in more detail with reference to FIG. 4. Upon authorizing each of the viewers, the content requests are sent to the multimedia content element manager 302. In addition, based on the content requests, the multimedia content element manager 302 instructs the live content streaming server 306 and/or on-demand content streaming server 310 to adaptively stream the requested live content and/or on-demand content, respectively, to the one or more of the mobile multimedia devices 214A-N. In context, if a viewer selects a program associated with the routed live content, the live content streaming server 306 adaptively streams the corresponding routed live content to an associated one of the mobile multimedia devices 214A-N. If the viewer selects a program associated with the routed on-demand content, the corresponding on-demand content is routed from the on-demand content repository 308 to the on-demand content streaming server 310. Further, the on-demand content streaming server 310 adaptively streams the routed on-demand content to the associated one of the mobile multimedia devices 214A-N. This is explained in more detail with reference to FIG. 4.

In addition in this embodiment, the adaptively streamed live content and/or on-demand content are adaptively decoded in each of the one or more of the mobile multimedia devices 214A-N. Also, the adaptively decoded live content and/or on-demand content are substantially simultaneously displayed by the one or more of the display devices 216A-N associated with the one or more of the mobile multimedia devices 214A-N. This is explained in more detail with reference to FIG. 6.

Referring now to FIG. 4, which is a block diagram 400 illustrating major modules residing in each of the major components in the multimedia streaming system 212, such as those shown in FIG. 3, according to one embodiment. As shown in FIG. 4, the multimedia content element manager 302 includes an admin 400, an operator 402, a channel admin 404, an editor 406, an admin interface 408, reports 410, an email management module 412, a content shaping module 414, a logging module 416, a log/metering upload module 418, a bandwidth manager module 420, a payment module 422, a configuration updates module 424, a client upgrade module 426 and a DRM renewals module 428.

Further as shown in FIG. 4, the TV server 304 includes a set-top box configuration module 430, an advertisement engine 432, a browse and search module 434, a subscription module 436, a registration module 438, a personalization recommendation engine 440, an authorization module 442, a connection manager 444A and a provisioning module 446. Furthermore as shown in FIG. 4, the live content streaming server 306 includes a DRM module 448A, an adaptive streaming module 450A and a connection manager 444B. In addition as shown in FIG. 4, the on-demand content streaming server 310 includes a DRM module 448B, an adaptive streaming module 450B and a connection manager 444C.

Moreover as shown in FIG. 4, the admin 400, the operator 402, the channel admin 404, the editor 406, the admin interface 408, the reports 410, the email management module 412, the content shaping module 414, the logging module 416, the log/metering upload module 418, the bandwidth manager module 420, the payment module 422, the configuration updates module 424, the client upgrade module 426 and the DRM renewals module 428 are communicatively coupled to each other. In addition, the set-top box configuration module 430, the advertisement engine 432, the browse and search module 434, the subscription module 436, the registration module 438, the personalization recommendation engine 440, the authorization module 442, the connection manager 444A and the provisioning module 446 are communicatively coupled to each other. Also, the DRM module 448A, the adaptive streaming module 450A and the connection manager 444B are communicatively coupled to each other. In addition, the DRM module 448B, the adaptive streaming module 450B and the connection manager 444C are communicatively coupled to each other.

In operation, the multimedia content element manager 302 receives the encoded content metadata, live content and/or on-demand content from the Internet 206. Further, the content shaping module 414 routes the encoded content metadata, live content and on-demand content to the TV server 304, live content streaming server 306 and the on-demand content streaming server 310, respectively. In this embodiment, the encoded on-demand content is routed to the on-demand content streaming server 310 via the on-demand content repository 308.

During an initial setup of the one or more of the mobile multimedia devices 214A-N, the registration module 438 registers the viewers associated with the one or more of the mobile multimedia devices 214A-N. Further, each of the viewers subscribes to view the routed live content and/or on-demand content using the associated one of the one or more of the mobile multimedia devices 214A-N. In one embodiment, if a viewer is a registered viewer then the DRM renewals module 428 enables the viewer to renew subscription to view the routed live content and/or on-demand content using the associated one of the one or more of the mobile multimedia devices 214A-N.

Further in operation, the browse and search module 434 provides the routed content metadata in the form of the list of programs associated with the routed live content and/or the on-demand content to the connection manager 444A to enable the viewers to select a program. Furthermore, the connection manager 444A sends the routed content metadata in the form of the list of programs to the one or more of the mobile multimedia devices 214A-N, shown in FIGS. 2 and 3.

In addition in operation, each of the viewers associated with the one or more of the mobile multimedia devices 214A-N browses through the list of programs associated with the routed live content and/or the on-demand content using the associated one of the one or more of the display devices 216A-N, shown in FIGS. 2 and 3. Also, each of the viewers selects a program from the list of programs associated with the routed live content and/or on-demand content. Based on the program selected by each of the viewers, corresponding content requests are sent to the TV server 304 by the associated one or more of the mobile multimedia devices 214A-N.

Upon receiving the content requests from each of the viewers, the subscription module 436 determines whether each of the viewers is a valid subscriber to view the selected program. If each of the viewers is a valid subscriber then the authorization module 442 authorizes each of the viewers to view the selected program associated with the routed live content and/or on-demand content. Upon authorization, the content requests are sent to the multimedia content element manager 302.

In addition in operation, based on the content requests, the multimedia content element manager 302 instructs the live content streaming server 306 and/or on-demand content streaming server 310 to adaptively stream the routed live content and/or on-demand content, respectively, to the one or more of the mobile multimedia devices 214A-N. In context, if a viewer selects a program associated with the routed live content, initially, the DRM module 448A in the live content streaming server 306 encrypts the routed live content to obtain rights associated with the routed live content. Further, the connection manager 444B replicates the routed live content based on the number of viewers of the routed live content. Furthermore, the adaptive streaming module 450A adaptively streams the replicated live content to the one of the mobile multimedia devices 214A-N, associated with the viewer, via the cellular network 208. In this embodiment, the adaptive streaming module 450A adaptively streams the routed live content based on available bandwidth in the cellular network 208.

Further in context, if the viewer selects a program associated with the routed on-demand content, the associated on-demand content is routed from the on-demand content repository 308 to the on-demand content streaming server 310. Further, the DRM module 448B in the on-demand content streaming server 310 encrypts the routed on-demand content to obtain rights associated with the routed on-demand content. Further, the connection manager 444C replicates the routed on-demand content based on a number of viewers of the routed on-demand content. In addition, the adaptive streaming module 450B adaptively streams the replicated on-demand content to one of the mobile multimedia devices 214A-N, associated with the viewer, via the cellular network 208. In this embodiment, the adaptive streaming module 450A adaptively streams the routed on-demand content based on the available bandwidth in the cellular network 208.

In addition in this embodiment, the adaptively streamed live content and/or on-demand content is adaptively decoded in each of the one or more mobile multimedia devices 214A-N. Also, the adaptively decoded live content and/or on-demand content are displayed on the one or more of the display devices 216A-N, shown in FIGS. 2 and 3, associated with the one or more of the mobile multimedia devices 214A-N. This is explained in more detail with reference to FIGS. 5 and 6.

Referring now to FIG. 5, which is a block diagram 500 illustrating major components in a mobile multimedia device 214 for receiving the multimedia content from the cellular network 208, according to one embodiment. Each of the mobile multimedia devices 214A-N, shown in FIGS. 2 and 3, includes components as shown in the mobile multimedia device 214. As shown in FIG. 5, the block diagram 500 includes the mobile multimedia device 214, a display device 216, speakers 512 and a remote control device 514. Further, the mobile multimedia device 214 includes a set-top box 502 and a dongle 520. Furthermore, the set-top box 502 includes a synchronous dynamic random access memory (SDRAM) 504, a flash memory 506, a video digital-to-analog converter (DAC) 508, an audio DAC 510, a media processor 516 and an universal serial bus (USB) port 518.

In addition as shown in FIG. 5, the display device 216 associated with the mobile multimedia device 214 is coupled to the video DAC 508. Moreover, the speakers 512 are coupled to the audio DAC 510. Also, the media processor 516 is coupled to the remote control device 514, the video DAC 508, the audio DAC 510, the SDRAM 504, the flash memory 506 and the USB port 518. Further, the dongle 520 is coupled to the media processor 516 via the USB port 518.

In this embodiment, the dongle 520 is a high speed data modem capable of receiving wireless signals from the cellular network 208, shown in FIG. 2. In operation, the mobile multimedia device 214 connects to the cellular network 208, shown in FIGS. 2 and 3, via the dongle 520. Further, the mobile multimedia device 214 receives the routed content metadata from the multimedia streaming system 212, shown in FIG. 2, via the dongle 520. Furthermore, the mobile multimedia device 214 receives the adaptively streamed live content and/or on-demand content from the multimedia streaming system 212, shown in FIG. 2, via the dongle 520. This is explained in more detail with reference to FIG. 4. Particularly, the set-top box 502 receives the adaptively streamed live content and/or on-demand content and the routed content metadata. In addition in operation, the media processor 516 adaptively decodes the adaptively streamed live content and/or on-demand content and substantially simultaneously displays the adaptively decoded live content and/or on-demand content and the routed content metadata on the display device 216. This is explained in more detail with reference to FIG. 6.

Referring now to FIG. 6, which is a block diagram 600 illustrating major components in the media processor 516 residing in the set-top box 502, such as those shown in FIG. 5, for receiving the multimedia content from the cellular network 208, according to one embodiment. As shown in FIG. 6, the block diagram 600 includes the media processor 516, the USB port 518, the audio DAC 510, the video DAC 508, the dongle 520, the speakers 512 and the display device 216. Further, the media processor 516 includes a Linux operating system 602, a multimedia streaming module 604, USB drivers 606, a video decoder 608, an audio decoder 610, input/output (I/O) plugins 612, a de-multiplexer (demux) 614, a DRM module 616, a player module 618, a browser 620, a graphical user interface (GUI) 622 and electronic program guide (EPG) 624.

Furthermore as shown FIG. 6, the media processor 516 is coupled to the dongle 520, the speakers 512 and the display device 216 via the USB port 518, the audio DAC 510 and the video DAC 508, respectively. In addition as shown in FIG. 6, the Linux operating system 602 is coupled to the multimedia streaming module 604, the video decoder 608, the audio decoder 610, the browser 620 and the GUI 622. Moreover, the multimedia streaming module 604 is coupled to the USB drivers 606 and the player module 618. Also, the player module 618 is coupled to the I/O plugins 612, the demux 614, the DRM module 616 and the EPG 624. Further, the I/O plugins 612, the demux 614 and the DRM module 616 are coupled to the video decoder 608 and the audio decoder 610. Furthermore, the EPG 624 is coupled to the browser 620 and the GUI 622.

In operation, a viewer associated with the mobile multimedia device 214, shown in FIG. 5, selects a program associated with the routed live content and on-demand content, from the list of programs, using the display device 216. In this embodiment, the list of programs is displayed on the display device 216 by the EPG 624 via the video DAC 508. Further, based on the program selected by the viewer, the associated routed live content or on-demand content is adaptively streamed to the mobile multimedia device 214 by the multimedia streaming system 212, shown in FIG. 2, via the cellular network 208. This is explained in more detail with reference to FIGS. 3 and 4. In one embodiment, the multimedia streaming module 604 receives the adaptively streamed live content and/or on-demand content via the dongle 520. Further, the multimedia streaming module 604 sends the received live content and/or on-demand content to demux 614 via the player module 618. The demux 614 separates audio content and video content from the received live content and/or on-demand content. Furthermore, the demux 614 sends the separated audio content and video content to the audio decoder 610 and the video decoder 608, respectively. The audio decoder 610 and the video decoder 608 then decodes the audio content and video content, respectively, and send the decoded audio content and video content back to the player module 618 via the I/O plugins 612 and the DRM module 616. In addition, the player module 618 sends the decoded audio content to the speakers 512 via the audio DAC 510. Also, the player module 618 sends the decoded video content to the display device 216 via the video decoder 508.

In this embodiment, the player module 618 determines the rate at which the audio content and video content associated with the received live content and/or on-demand content are decoded. Based on the rate at which the audio content and video content are decoded, the player module 618 sends feedback information to the multimedia streaming module 604. Further, based on the received feedback information, the multimedia streaming module 604 determines the available bandwidth and a bit rate at which the adaptively streamed live content and/or on-demand content are received.

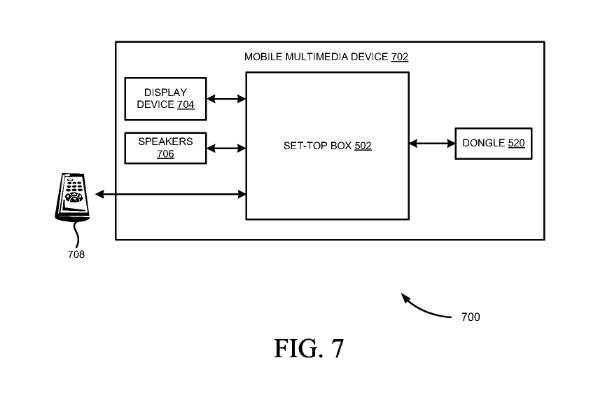

Referring now to FIG. 7, which is a block diagram 700 illustrating a display device 704 and speakers 706 integrated into a mobile multimedia device 702, according to one embodiment. Particularly, FIG. 7 illustrates an exemplary implementation of the mobile multimedia device 702. As shown in FIG. 7, the mobile multimedia device 702 includes the display device 704, the speakers 706, the set-top box 502 and the dongle 520. Further, a remote control device 708 associated with the mobile multimedia device 702 is coupled to the set-top box 502 via a wireless connection, such as infrared and the like. Exemplary mobile multimedia devices with integrated display device, speakers, set-top box and dongle include mobile phone, personal digital assistant (PDA) and the like.

In operation, the mobile multimedia device 702 receives the adaptively streamed live content and/or on-demand content and routed content metadata from the multimedia streaming system 212 via the cellular network 208. This is explained in detail with reference to FIGS. 2 to 4. Further, the adaptively streamed live content and/or on-demand content are adaptively decoded by the set-top box 502. Furthermore, the adaptively decoded live content and/or on-demand content and the routed content metadata are substantially simultaneously displayed on the display device 704. This is explained in detail with reference to FIGS. 5 and 6.

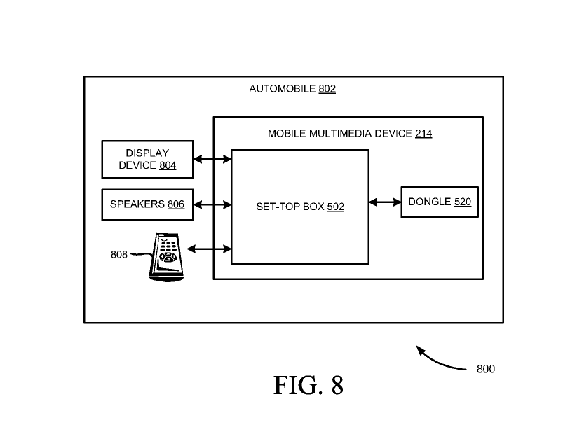

Referring now to FIG. 8, which is a block diagram 800 illustrating the mobile multimedia device 214, such as the one shown in FIGS. 2 and 3, installed inside an automobile 802 for receiving the multimedia content from the cellular network 208, according to one embodiment. Particularly, FIG. 8 illustrates an exemplary implementation of the mobile multimedia device 214. As shown in FIG. 8, the automobile 802 includes the mobile multimedia device 214, a display device 804 and speakers 806. Further, a remote control device 808 is associated with the mobile multimedia device 214. Furthermore, the mobile multimedia device 214 includes the set-top box 502 and the dongle 520. For example, the remote control device 808 is coupled to the set-top box 502 via a wireless connection, such as infrared and the like.

In operation, the mobile multimedia device 214 receives the adaptively streamed live content and/or on-demand content and routed content metadata from the multimedia streaming system 212 via the cellular network 208. This is explained in detail with reference to FIGS. 2 to 4. Further, the adaptively streamed live content and/or on-demand content are adaptively decoded by the set-top box 502. Furthermore, the adaptively decoded live content and/or on-demand content and the routed content metadata are substantially simultaneously displayed on the display device 804. This is explained in detail with reference to FIGS. 5 and 6.

In various embodiments, the system and method described in FIGS. 1 through 8 provide a seamless multimedia content viewing experience to viewers using associated mobile multimedia devices. Further, the mobile multimedia devices obtains the multimedia content from Internet via a cellular network and provide the multimedia content to the viewers without choking Internet bandwidth.

A skilled person will recognize that many suitable designs of the systems and processes may be substituted for or used in addition to the configurations described above. It should be understood that the implementation of other variations and modifications of the embodiments of the invention and its various aspects will be apparent to one ordinarily skilled in the art, and that the invention is not limited by the exemplary embodiments described herein. Therefore, it is contemplated to cover the present embodiments of the invention and any and all modifications, variations, or equivalents that fall within the true spirit and scope of the basic underlying principles disclosed herein. The contents of all references cited are incorporated herein by reference in their entireties.

1. A method of streaming multimedia content via a cellular network to mobile multimedia devices, comprising:
receiving an encoded multimedia stream via Internet by the cellular network, wherein the encoded multimedia stream comprises content metadata, live content and/or on-demand content;
routing the encoded content metadata, live content and/or on-demand content by a multimedia streaming system in the cellular network;
sending the routed content metadata to one or more of the mobile multimedia devices via the cellular network by the multimedia streaming system;
adaptively streaming the routed live content and/or on-demand content to the one or more of the mobile multimedia devices via the cellular network by the multimedia streaming system; and
adaptively decoding the adaptively streamed live content and/or on-demand content by each of the one or more mobile multimedia devices.

2. The method of claim 1, further comprising:
substantially simultaneously displaying the adaptively decoded live content and/or on-demand content and the routed content metadata by one or more display devices associated with the one or more of the mobile multimedia devices.

3. The method of claim 1, further comprising:
receiving a coded multimedia stream from a multimedia broadcasting satellite by a multimedia content ingestion centre; and
encoding the received coded multimedia stream to a format suitable for transmission to the cellular network by the multimedia content ingestion centre.

4. The method of claim 1, wherein routing the encoded content metadata, live content and/or on-demand content by the multimedia streaming system in the cellular network comprises:
routing the encoded content metadata to a television (TV) server, live content to a live content streaming server and/or on-demand content to an on-demand content streaming server via an on-demand content repository by a multimedia content element manager residing in the multimedia streaming system.

5. The method of claim 4, wherein sending the routed content metadata to the one or more of the mobile multimedia devices via the cellular network by the multimedia streaming system comprises:
sending the routed content metadata to the one or more of the mobile multimedia devices by an associated connection manager in the TV server.

6. The method of claim 4, wherein adaptively streaming the routed live content and/or on-demand content to the one or more of the mobile multimedia devices via the cellular network by the multimedia streaming system comprises:
adaptively streaming the routed live content to the one or more of the mobile multimedia devices by the live content streaming server in the multimedia streaming system; and
adaptively streaming the routed on-demand content to the one or more of the mobile multimedia devices from the on-demand content repository by the on-demand content streaming server in the multimedia streaming system.

7. The method of claim 6, wherein the routed live content and on-demand content are adaptively streamed to the one or more of the mobile multimedia devices by the live content streaming server and the on-demand content streaming server, respectively, using an associated adaptive streaming module, a digital rights management (DRM) module and a connection manager.

8. The method of claim 1, wherein adaptively decoding the adaptively streamed live content and/or on-demand content by each of the one or more mobile multimedia devices comprises:
adaptively decoding the adaptively streamed live content and/or on-demand content by an associated multimedia streaming module and a player module, in a set-top box, in each of the one or more mobile multimedia devices.

9. A system for streaming multimedia content via a cellular network to mobile multimedia devices, comprising:
a multimedia streaming system residing in a cellular network base station associated with the cellular network; and
a plurality of mobile multimedia devices coupled to the multimedia streaming system via the cellular network, wherein the multimedia streaming system receives encoded multimedia stream via Internet, wherein the encoded multimedia stream comprises content metadata, live content and/or on-demand content, wherein the multimedia streaming system routes the encoded content metadata, live content and/or on-demand content, wherein the multimedia streaming system sends the routed content metadata to one or more of the plurality of mobile multimedia devices via the cellular network, wherein the multimedia streaming system adaptively streams the routed live content and/or on-demand content to the one or more of the plurality of mobile multimedia devices via the cellular network, and wherein each of the one or more mobile multimedia devices adaptively decodes the adaptively streamed live content and/or on-demand.

10. The system of claim 9, further comprising:
a plurality of display devices coupled to the associated plurality of mobile multimedia devices for substantially simultaneously displaying the adaptively decoded live content and/or on-demand content and the routed content metadata.

11. The system of claim 9, further comprising:
a multimedia broadcasting satellite; and
a multimedia content ingestion centre communicatively coupled to the multimedia broadcasting satellite, wherein the multimedia content ingestion centre is further coupled to the multimedia streaming system via Internet, wherein the multimedia content ingestion centre receives a coded multimedia stream from the multimedia broadcasting satellite and wherein the multimedia content ingestion centre encodes the received coded multimedia stream to a format suitable for transmission to the cellular network.

12. The system of claim 9, wherein the multimedia streaming system comprises:
a multimedia content element manager;
a television (TV) server coupled to the multimedia content element manager;
a live content streaming server coupled to the multimedia content element manager; and
an on-demand content streaming server coupled to the multimedia content element manager via an on-demand content repository, wherein the multimedia content element manager routes the encoded content metadata to the TV server, live content to the live content streaming server and the on-demand content to the on-demand content streaming server via the on-demand content repository.

13. The system of claim 12, wherein the TV server comprises a connection manager, wherein the connection manager sends the routed content metadata to the one or more of the plurality of mobile multimedia devices.

14. The system of claim 12, wherein the live content streaming server and the on-demand content streaming server adaptively streams the routed live content and on-demand content, respectively, to the one or more of the plurality of mobile multimedia devices.

15. The system of claim 14, wherein the live content streaming server comprises an associated adaptive streaming module, a digital rights management (DRM) module and a connection manager, wherein the associated adaptive streaming module, DRM module and connection manager adaptively streams the routed live content to the one or more of the plurality of mobile multimedia devices.

16. The system of claim 14, wherein the on-demand content streaming server comprises an associated adaptive streaming module, DRM module and connection manager, wherein the associated adaptive streaming module, DRM module and connection manager adaptively streams the routed on-demand content to the one or more of the plurality of mobile multimedia devices.

17. The system of claim 9, wherein each of the plurality of mobile multimedia devices comprises:
a set-top box, wherein the set-top box comprises:
a multimedia streaming module; and
a player module coupled to the multimedia streaming module; and
a dongle coupled to the set-top box, wherein the multimedia streaming module and player module adaptively decode the adaptively streamed live content and/or on-demand content.
